(19) United States
(12) Patent Application Publication
(10) Pub. No.: US 2015/0229129 A1
(43) Pub. Date: Aug. 13, 2015

(54) POWER RELAY DEVICE, AND POWER CONSUMPTION REDUCTION METHOD

(71) Applicant: FUJITSU LIMITED, Kawasaki-shi (JP)

(72) Inventor: Yoshimasa Kimura, Kawasaki (JP)

(73) Assignee: FUJITSU LIMITED, Kawasaki-shi (JP)

(21) Appl. No.: 14/693,423

(22) Filed: Apr. 22, 2015

Related U.S. Application Data
(63) Continuation of application No. PCT/JP2012/078544, filed on Nov. 2, 2012.

(51) Int. Cl. H02J 3/00; G05F 3/04

(52) U.S. Cl. CPC H02J 3/00; G05F 3/04

(57) ABSTRACT

In one system, a power relay device comprises one or more outlets configured to supply power to a downstream side, a communication device configured to communicate with the downstream side connected to the outlet for each of the outlets, and a processor configured to be able to issue, by using the communication device, a request to operate a power-saving function to a first electric appliance having the power-saving function among electric appliances positioned on the downstream side of the outlet for each of the outlets.

### CROSS-REFERENCE TO RELATED APPLICATION

This application is a continuation application of International Application PCT/JP2012/78544 filed on Nov. 2, 2012 and designated the U.S., the entire contents of which are incorporated herein by reference.

### FIELD

The embodiments discussed herein are related to a technique for reducing (suppressing) power consumption for the whole of an appliance to which power is supplied.

### BACKGROUND

It is general to supply power to a facility such as a building or the like within a range up to a predetermined contracted capacity. To avoid an abnormal power supply that exceeds the contracted capacity, a circuit breaker such as a fuse or the like is generally provided in a facility.

It is general that many electric appliances are used in a facility such as a building or the like. When a circuit breaker is actuated, a power supply to all electric appliances to which power is supplied via the actuated circuit breaker is instantly shut off.

However, for some electric appliances, a power supply is preferable to shut off instantly. Byway of example, a certain length of time is needed to halt an information processing device such as a PC (Personal Computer) or the like, and a problem such that needed data is lost can occur with high probability when a power supply is instantly shut off. Moreover, it can be said that power may be continuously supplied to light fixtures, firefighting equipment and the like for safety. Thus, it is preferable not to actuate a circuit breaker that is provided in a facility in advance.

Power is supplied to an electric appliance via a plurality of power relay devices such as a main power switchboard, a power switchboard, a wall socket and the like. Accordingly, some conventional power relay devices such as a power strip provided with one or more sockets can shut off a power supply performed via a socket. When such power relay devices are used, power consumption of the whole of a facility is suppressed by shutting off each power supply performed via a socket so that a circuit breaker provided in advance is not actuated.

For an electric appliance connected to a conventional power relay device, a power supply is shut off on a priority basis as needed. Accordingly, it is preferable to connect an electric appliance for which a power supply may be shut off on a priority basis to the conventional power relay device.

[Patent Document 1] Japanese Laid-open Patent Publication No. 2006-146293

[Patent Document 2] Japanese Laid-open Patent Publication No. 2003-32290

[Patent Document 3] Japanese Laid-open Patent Publication No. 2005-4243

[Patent Document 4] International Publication Pamphlet No. WO 04/53696

### SUMMARY

According to an aspect of the embodiments, a power relay device comprises one or more outlets configured to supply power to a downstream side, a communication device configured to communicate with the downstream side connected to the outlet for each of the outlets, and a processor configured to be able to issue, by using the communication device, a request to operate a power-saving function to a first electric appliance having the power-saving function among electric appliances positioned on the downstream side of the outlet for each of the outlets.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of a configuration example of a power distribution system built by using power relay devices according to an embodiment.

FIG. 2 is an explanatory diagram of a configuration example of a power control device equipped in the power relay devices according to the embodiment.

FIG. 3 is an explanatory diagram of a configuration example of a terminal equipped with a power management device.

FIG. 4 is a flowchart illustrating a measurement process.

FIG. 5 is a flowchart illustrating a power-saving process.

FIG. 6 is a flowchart illustrating a power-saving mode switching process.

FIG. 7 is a flowchart illustrating a shut-off control process.

FIG. 8 is an explanatory diagram of an example of actually used power relay devices, and terminals respectively connected to the power relay devices.

FIG. 9 is an explanatory diagram of content of power management information retained in each of the power relay devices in the case of the connection configuration illustrated in FIG. 8.

FIG. 10A is an explanatory diagram (No. 1) of a change in content of power management information retained in each of the power relay devices in a way such that the power relay device executes the power-saving process when 6000 W is input as a power-saving target value.

FIG. 10B is an explanatory diagram (No. 2) of a change in content of power management information retained in each of the power relay devices in a way such that the power relay device executes the power-saving process when 6000 W is input as the power-saving target value.

FIG. 10C is an explanatory diagram (No. 3) of a change in content of power management information retained in the power relay devices in a way such that the power relay device executes the power-saving process when 6000 W is input as the power-saving target value.

FIG. 10D is an explanatory diagram (No. 4) of a change in content of power management information retained in the power relay devices in a way such that the power relay device executes the power-saving process when 6000 W is input as the power-saving target value.

FIG. 11A is an explanatory diagram (No. 1) of a change in content of power management information retained in each of the power relay devices in a way such that the power relay device executes the power-saving process when 5600 W is input as a power-saving target value.

FIG. 11B is an explanatory diagram (No. 2) of a change in content of power management information retained in each of the power relay devices in a way such that the power relay device executes the power-saving process when 5600 W is input as the power-saving target value.

FIG. 11C is an explanatory diagram (No. 3) of a change in content of power management information retained in each of the power relay devices in a way such that the power relay device executes the power-saving process when 5600 W is input as the power-saving target value.

FIG. 11D is an explanatory diagram (No. 4) of a change in content of power management information retained in each of the power relay devices in away such that the power relay device executes the power-saving process when 5600 W is input as the power-saving target value.

### DESCRIPTION OF EMBODIMENTS

A power supply to an electric appliance is performed on the premise that the appliance is used. Therefore, when power is supplied even to an electric appliance, for example, having a low use frequency or a low degree of importance, there is a probability that a person who uses or is going to use the appliance is present. A shut-off of a power supply to an electric appliance directly or indirectly exerts an ill effect on a person who uses or is going to use the appliance, leading to a degradation of operating efficiency. Accordingly, it is preferable not to shut off a power supply even to an electric appliance comprehensively having a low degree of importance.

Embodiments according to the present invention are described in detail below with reference to the drawings.

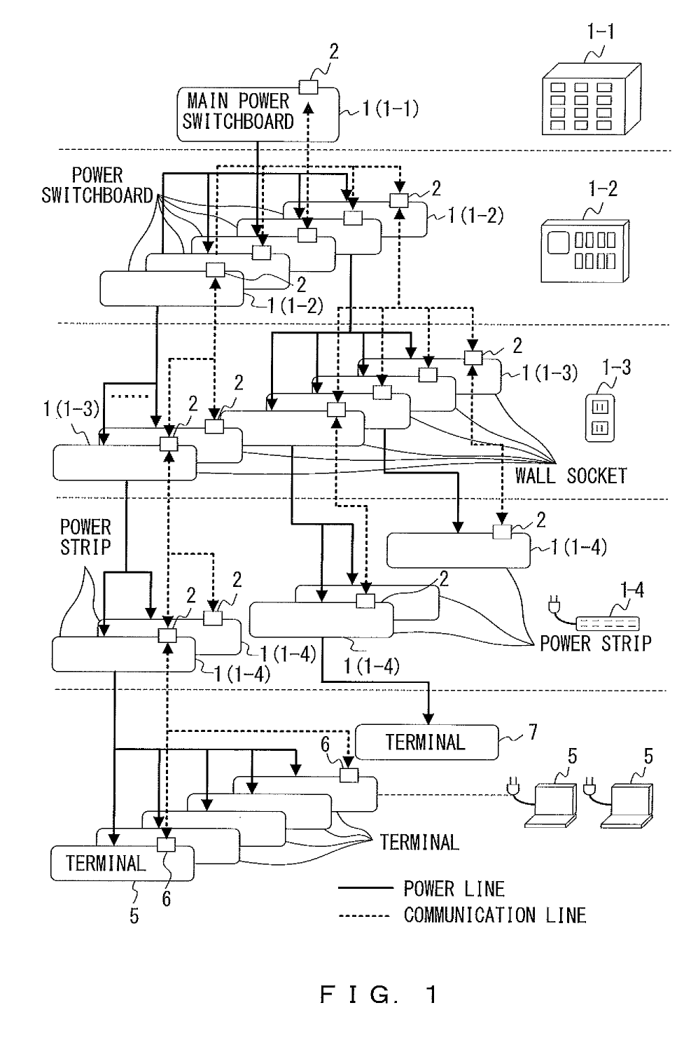

FIG. 1 is an explanatory diagram of a configuration example of a power distribution system built by using power relay devices according to an embodiment. This power distribution system is a system built to distribute power supplied to a facility such as a building, a factory or the like to electric appliances 5 and 7. As illustrated in FIG. 1, power supplied to the facility can be supplied to the electric appliances 5 and 7 via a main power switchboard 1(1-1), one of a plurality of power switchboards 1(1-2), and one of a number of wall sockets 1(1-3). FIG. 1 illustrates a state where power is supplied to the electric appliances 5 and 7 via a power strip 1(1-4) in addition to a wall socket 1(1-3). In FIG. 1, the electric appliances 5 and 7 are expressed as “terminals”. Hereinafter, electric appliances are expressed as terminals. A configuration of the power distribution system is not limited to the example illustrated in FIG. 1.

All the main power switchboard 1-1, the power switchboards 1-2 and the wall sockets 1-3, and most of the power strips 1-4 illustrated in FIG. 1 are equipped with a power control device 2. All the main power switchboard 1-1, the power switchboards 1-2, the wall sockets 1-3, and the power strips 1-4 are power relay devices that supply power fed from an upstream side to a downstream side. All the main power switchboard 1-1, the power switchboards 1-2, the wall sockets 1-3, and the power strips 1-4 that are equipped with the power control device 2 are power relay devices according to this embodiment. When there is no need to particularly limit a type of a power relay device, the power relay device is hereinafter referred to as a “power relay device 1”.

Solid-line arrows in FIG. 1 represent a direction in which power is supplied via a power line. Dotted-line arrows in FIG. 1 represent a target with which the power control device 2 equipped in each of the power relay devices 1 communicates. The power control device 2 equipped in each of the power relay devices 1 can communicate with the power control device 2 of the power relay device 1 positioned on an upstream side, the power control device 2 of the power relay device 1 positioned on a downstream side, or a power management device 6 of the terminal 5. On the upstream side of the main power switchboard 1-1, a power relay device arranged by the facility is not present. Accordingly, the power control device 2 equipped in the main power switchboard 1-1 only communicates with the downstream side.

As illustrated in FIG. 1, the power management device 6 equipped in the terminal 5 can communicate with the power control device 2 of the power relay device 1 positioned on the upstream. The terminal 7 that is not equipped with the power management device 6 does not perform this communication. Therefore, a distinction is made between the terminals 5 and 7. In this embodiment, the power management device 6 is equipped in the terminal 5 having a power-saving function. The reason is as follows.

Currently, a power-saving function that can further reduce power consumption than usual is widely equipped in electric appliances. For example, PCs are equipped with not only a power-saving function that causes a PC to make a transition to a sleep state but a power-saving function that reduces power consumption by decreasing a clock frequency of a Central Processing Unit (CPU). The power-saving function that causes the PC to make a transition to the sleep state is widely equipped also in Office Automation (OA) appliances such as a copier, a printer and the like. Some power-saving functions reduce power consumption by shutting off a power supply to a circuit having a comparatively low use frequency.

Thus, the power-saving function of the terminal 5 is actively utilized to reduce the power consumption of the whole of the facility in this embodiment. By actively utilizing the power-saving function of the terminal 5, the number of the terminals 5 or 7 for which a power supply is shut off can be further reduced. As a result, also an ill effect directly or indirectly exerted by shutting off the power supply to the terminal 5 or 7 can be further prevented.

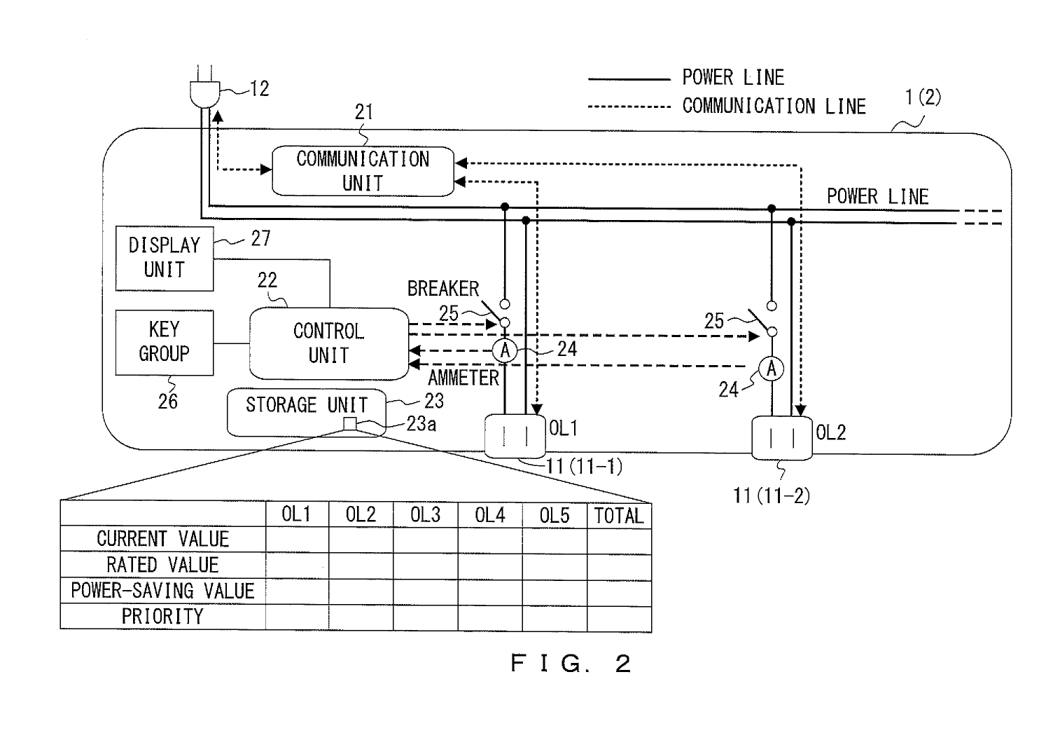

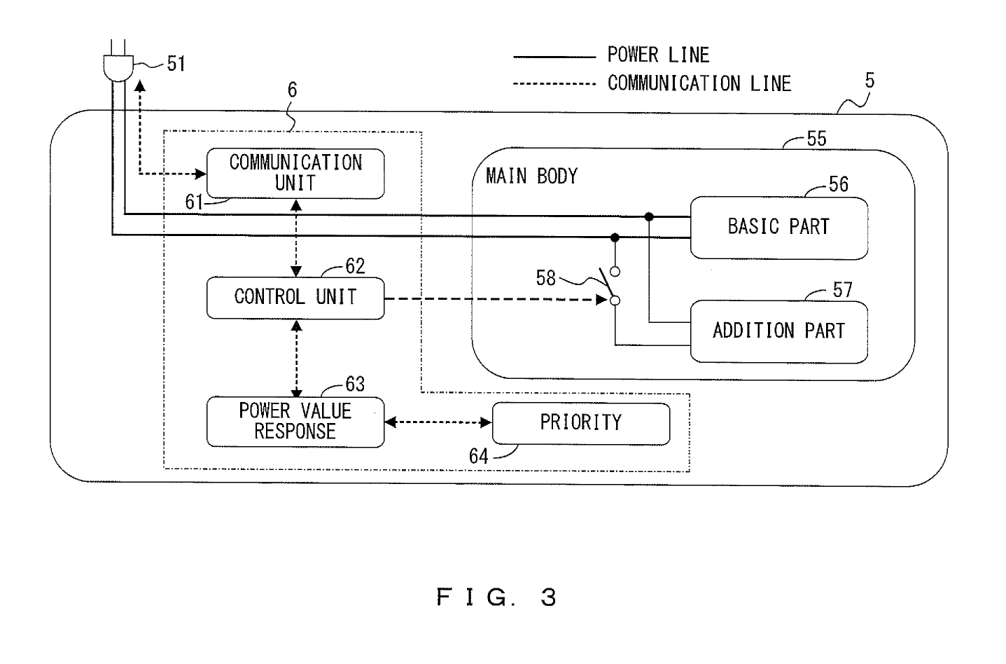

FIG. 2 is an explanatory diagram of a configuration example of the power control device equipped in the power relay device according to this embodiment. FIG. 3 is an explanatory diagram of a configuration example of the terminal equipped with the power management device. Configurations of the power relay device 1 and the terminal 5 are specifically described next with reference to FIGS. 2 and 3.

The configuration of the terminal 5 is initially described with reference to FIG. 3.

As illustrated in FIG. 3, the terminal 5 has a configuration such that a power supply plug 51 is provided and power supplied via the plug 51 is input to a main body 55. The main body 55 includes a basic part 56 to which power is supplied even in a power-saving mode that reduces power with the power-saving function, an addition unit 57 to which power is not supplied in the power-saving mode, and a breaker 58 that can shut off a power supply to the addition unit 57. Thus, the terminal 5 can be configured to reduce power consumption by shutting off a power supply or canceling the shut-off of the power supply to the addition unit 57 depending on whether the power-saving mode is set.

The configuration illustrated in FIG. 3 is merely one example, and power consumption may be reduced in accordance with a type of the terminal 5. Thus, the power-saving function equipped in the terminal 5 is not limited. Power consumption may be reduced, for example, by changing a frequency of a clock used for a process, or by decreasing a response speed of each unit. Here, for the sake of an explanation, all the terminals 5 are assumed to have the configuration illustrated in FIG. 3.

The power management device 6 includes a communication unit 61, a control unit 62, a power value response unit 63, and a storage unit 64. The communication unit 61 communicates, via a power line, with the power control device 2 of a power relay device 1 positioned on an upstream side. The power control device 2 issues, to the power management device 6, instructions such as a transmission of information about the terminal 5, a transition to the power-saving mode, and the like.

The control unit 62 processes an instruction received by the communication unit 61. A transition to the power-saving mode is performed by shutting off a power supply to the breaker 58 within the main body 55.

To the power value response unit 63, a power consumption value is input, for example, from the main body 55 as needed, and the power value response unit 63 outputs the power consumption value to the control unit 62 in response to a request from the control unit 62. The storage unit 64 stores information such as a priority, a rated value, and a power-saving value as information about the terminal 5.

The priority is a value that represents a priority when a power supply is shut off. In this embodiment, as the value increases, a power supply less is shut off. Therefore, a priority having a larger value is assigned to the terminal 5 for which a power supply less is shut off.

The rated value is a maximum value of power consumption assumed by the terminal 5. The power-saving value is a maximum value of power consumption when the power-saving mode is set.

These items of information stored in the storage unit 64 are read by the power value response unit 63 in accordance with an instruction of the control unit 62, and output to the control unit 62. The control unit 62 causes the communication unit 61 to transmit these items of information input from the power value response unit 63 to the power control device 2 of the power relay device 1 on an upstream side. Thus, the power control device 2 of each of the power relay devices 1 can directly recognize the presence of the terminal to which power is supplied, and can obtain, from the terminal 5, information will control power consumption.

The above described priority can be changed in accordance with an instruction received by the communication unit 61. This is because there is a possibility that the degree of importance of the terminal 5 varies depending on a user of the terminal 5, a department in which the terminal 5 is used, or the like. Therefore, this embodiment enables a control of the possibility of shutting off a power supply on a priority basis depending on a user, a department, a situation or the like. The priority may be fixed when there is no need to change the priority depending on a department, a situation or the like.

The configuration of the power relay device 1 is described next with reference to FIG. 2.

The configuration example illustrated in FIG. 2 is that in the case of the power strip 1-4. As illustrated in FIG. 2, the power strip 1-4, which is the power relay device 1, is provided with a plurality of sockets 11 (11-1, 11-2, . . . ), and a plug 12 for connecting to the wall socket 1-3. The power control device includes a communication unit (communication device) 21, a control unit (processor) 22, a storage unit 23, an ammeter 24 arranged for each of the sockets 11, a breaker 25 arranged for each of the sockets 11, a key group 26, and a display unit 27. An appliance provided for a power supply to the power relay device 1 is not limited to the socket 11. Therefore, the socket 11 is hereinafter referred to as an outlet. Namely, an outlet is used as a generic name of a plug for supplying power to a downstream side. “OL” depicted in FIG. 2 is an abbreviation of an outlet. “OL1” represents the outlet 11-1. “1” in the “OL1” and “11-1” is identification information of an outlet 11, and each outlet 11 is expressed by using the identification information. The identification information is hereinafter referred to as an outlet number.

The communication unit 21 performs a communication via a power line. The ammeter 24 and the breaker 25 that are arranged for each of the outlets 11 are respectively used to measure a power supply performed via a corresponding outlet 11, and to shut off the power supply. The control unit 22 controls a reference of results of a measurement of the ammeter 24, and the breaker 25. The reason why the ammeter 24 is used to measure power is that a supply of power having a fixed voltage is assumed. The storage unit 23 is a storage device that the control unit 22 uses for a process. In the storage unit 23, power management information 23a is stored. The power management information 23a is information in a form where various items of information such as the current value, a rated value, and a power-saving value of power consumption, and a priority are collected for each of the outlets 11.

The current value is a value of power consumption obtained from results of a measurement of the ammeter 24. The rated value is a rated value transmitted from a terminal 5 when the terminal 5 is connected on a downstream side. When the terminal 5 is not connected on the downstream side, the current value is handled as the rated value.

The power-saving value is a value of power consumption when the terminal 5 positioned on the downstream side is caused to make a transition to the power-saving mode. When the terminal 5 is not connected on the downstream side, the current value is handled as the power-saving value. The priority is identified depending on the terminal 5 or 7 present on the downstream side. In this embodiment, the priority of the terminal 7 that does not perform a communication via a power line is assumed to be the lowest 1. When a plurality of terminals 5 are present on the downstream side, the highest priority of the terminals 5 is adopted. Thus, there is a possibility that the priority is 2 or higher only when one or more terminals 5 are present on the downstream side.

When it is preferable to clarify a relationship with a corresponding outlet 11, the current value of an outlet 11-1 to which the reference numeral 11-1 is assigned is hereinafter expressed as a “current value (OL1)”. When the corresponding outlet 11 is unclear or does not need to be identified, it is expressed as a “current value (OLx)”. Also other rated values, power-saving values and the like are expressed by using this notation.

“Total” expressed within the power management information 23a represents a total value of the outlets 11. The total value is calculated for all the current value, the rated value, the power-saving value, and the priority. For the priority, a maximum value of the priorities of the outlets 11 is adopted similarly to the priority of each outlet 11.

In this embodiment, power consumption is reduced (suppressed) when a target value is input. This is because an input of a target value is recognized as being performed by intending a reduction in power consumption. An administrator can use the key group 26 and the display unit 27 in order to specify (input) a target value. Since input information may be information representing the amount of power that may be supplied, it may be information other than a target value. The input information may be, for example, information representing the amount of power to be reduced.

The current value (OLx) verified for each of the outlets 11 by the power control device 2 having the configuration illustrated in FIG. 2 is equivalent to a total amount of power supplied to a downstream side via a corresponding outlet 11. This means that the power relay device 1 positioned on a further upstream side can verify a power consumption value in a wider range. Thus, in this embodiment, the power relay device 1 as an origin, and the power relay device 1 positioned on the downstream side of the power relay device 1 as the origin are caused to execute the process for controlling power consumption. As a result, power consumption within a range where power consumption is to be reduced can be reduced.

For the power relay device 1 positioned on the downstream side of the power relay device 1 as the origin, a directly connected power relay device 1 on an upstream side specifies a target value. The power relay device 1 for which the target value is specified performs a control for making the amount of power supplied to a further downstream side equal to or smaller than the target value. Thus, the above described key group 26 and display unit 27 are not essential components. The target value specified by an administrator or the power relay device 1 is hereinafter referred to as a “power-saving target value”.

The amount of power consumption reduced by each power relay device 1 depends on a terminal present on a further downstream side of the corresponding power relay device 1. When not the terminal 5 but only the terminal 7 is present on the downstream side, power consumption is not reduced by a transition made to the power-saving mode. However, for a different power relay device 1, power consumption equal to or higher than a power-saving target value can be possibly reduced by the terminal 5 present on the downstream side. Thus, the power relay device 1 as the origin causes all the terminals that can make a transition to the power-saving mode to make a transition to the power-saving mode, when the current value (total) is larger than the target value. When the current value (total) exceeds the target value even though all the terminals make a transition to the power-saving mode, the power relay device 1 as the origin shuts off a power supply to a needed number of terminals 5 or 7 in accordance with priorities.

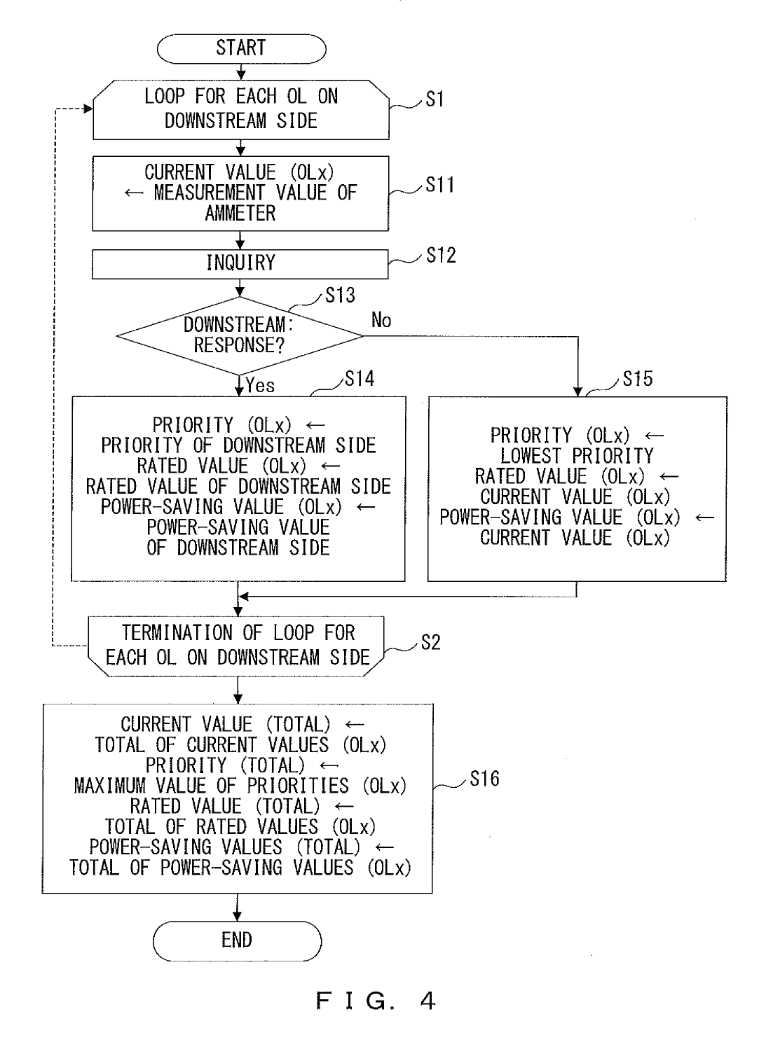

The power control device 2 of each of the power relay devices 1 executes the following process in accordance with a situation. This process is described in detail with reference to FIGS. 4 to 7.

FIG. 4 is a flowchart illustrating a measurement process. This measurement process is a process, executed by the control unit 22, for verifying the amount of power supplied from a local power relay device 1 to a downstream side, and for obtaining information needed to control a power supply. In the power relay device 1 positioned on the most upstream side, the measurement process is executed, for example, each time a predetermined length of time elapses. In a power relay device 1 on a further downstream side, this measurement process is executed directly by a request issued from a connected power relay device 1 on the upstream side. The power management information 23a stored in the storage unit 23 is created or updated by executing this measurement process. This measurement process is initially described in detail with reference to FIG. 4.

In this measurement process, a process loop (S1) for identifying the current value (OLx), a priority (OLx), a rated value (OLx), and a power-saving value (OLx) for each of the outlets 11 is initially executed. In this process loop of S1, the control unit 22 obtains a measurement value of the ammeter 24 of an outlet 11 to be targeted, calculates a power consumption value from the obtained measurement value, and stores the calculated power consumption value in the power management information 23a as the current value (OLx) (S11). The outlet 11 to be initially targeted is, for example, an outlet 11 having the smallest outlet number. An outlet 11 to be targeted next is an outlet 11 having the second smallest outlet number.

Next, the control unit 22 makes an inquiry to a terminal 5 connected to the outlet 11 to be targeted by issuing an instruction to the communication unit 21 (S12). The control unit 22 determines whether a response to the inquiry is made from a downstream side after the control unit 22 has made the inquiry (S13).

When the terminal 5 connected to the outlet 11 to be targeted is present, the control unit 62 of the terminal 5 causes the communication unit 61 to transmit information such as a power consumption value, a rated value, and a priority as a response. Thus, the determination of S13 results in “YES”, and the control unit 22 stores the received priority, rated value and power-saving value in the power management information 23a respectively as the priority (OLx), the rated value (OLx), and the power-saving value (OLx) (S14). Thereafter, when a different outlet 11 to be targeted is present, a target outlet is changed, and the process of S11 is again executed.

In the meantime, when the terminal 5 connected to the outlet 11 to be targeted is not present, the communication unit 21 does not receive the response to the inquiry. Thus, the determination of S13 results in “NO”, and the smallest value “1” and the current value (OLx) are stored in the power management information 23a respectively as the priority (OLx), the rated value (OLx) and the power-saving value (OLx) (S15). Thereafter, when a different outlet 11 to be targeted is present, a target outlet is changed, and the process of S11 is again executed.

When the different outlet to be targeted is not present, the process loop of S1 is terminated, and the flow proceeds to S16. In S16, the control unit 22 respectively obtains the current value (total), the priority (total), the rated value (total) and the power-saving value (total), and stores the obtained values in the power management information 23a. The obtained current value (total) is the total value (expressed as the “total of current values (OLx)” in FIG. 4) of the current values (OLx) of the outlets 11. The priority (total) is the maximum value (expressed as the “maximum value of the priorities (OLx)” in FIG. 4) of the priorities (OLx) of the outlets 11. The rated value (total) is the total value (expressed as the “total of the rated values (OLx)” in FIG. 4) of the rated values (OLx) of the outlets 11. The power-saving value (total) is the total value (expressed as the “total of power-saving values (OLx)” in FIG. 4) of the power-saving values (OLx) of the outlets 11. This measurement process is terminated after the control unit 22 stores, in the power management information 23a, the obtained current value (total), priority (total), rated value (total), and power-saving value (total).

When a different power relay device 1 is further connected to the outlet 11, the power relay device 1 executes the measurement process at the timing when the above described inquiry is made. Thus, all power relay devices present on the downstream side of the outlet 11 respectively execute the measurement process.

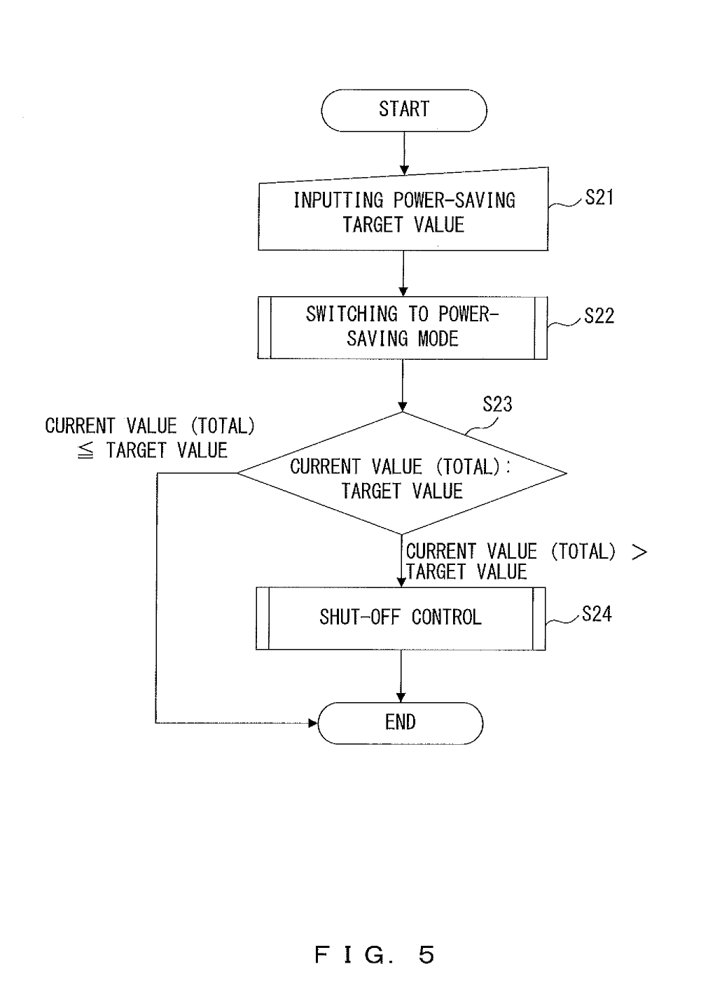

FIG. 5 is a flowchart illustrating a power-saving process. The power-saving process illustrated in FIG. 5 is a process executed by the control unit 22, for example, at the timing when a power-saving target value is input. The power-saving process is described in detail next with reference to FIG. 5. For an input of the power-saving target value, an administrator operates the key group 26, or the communication unit 21 receives from a power relay device 1 on an upstream side.

Initially, the control unit 22 obtains the power-saving target value input by operating the key group 26, or by being received by the communication unit 21 (S21). Next, the control unit 22 executes a power-saving mode switching process (S22).

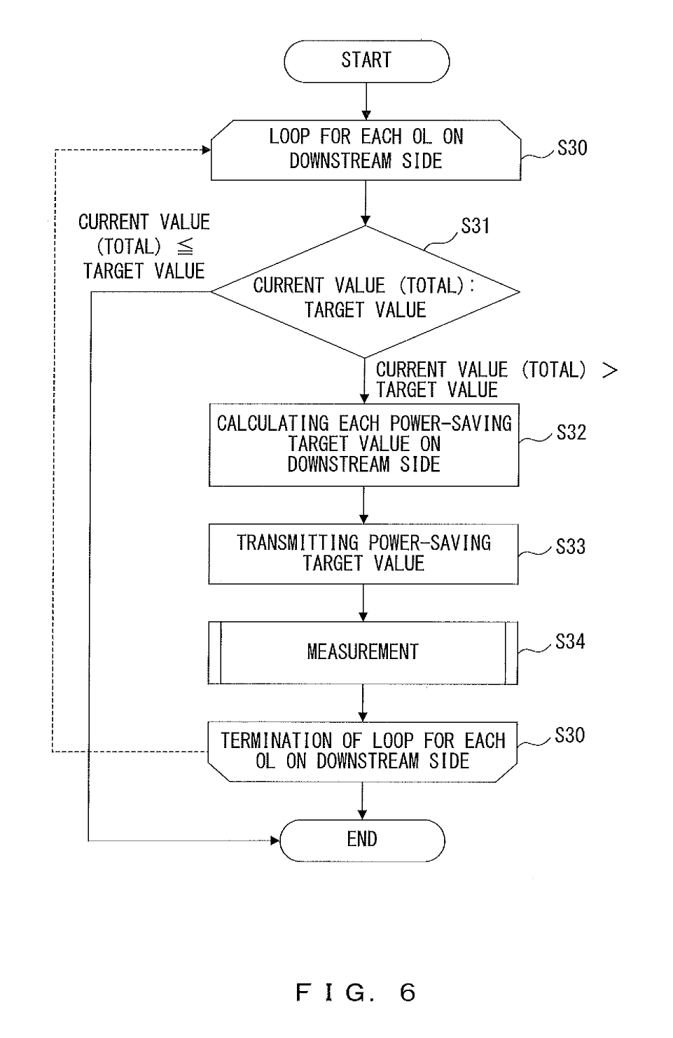

The power-saving mode switching process is a process for switching a terminal 5 present on a downstream side from a normal mode to the power-saving mode. Here, the power-saving mode switching process is described in detail with reference to the flowchart illustrated in FIG. 6.

In the power-saving mode switching process, a process loop (S30) for deciding a power-saving target value in an outlet 11 to be targeted while changing a target outlet 11, and for issuing a request to save power to a downstream side connected to the outlet 11 to be targeted is executed. Specifically, the following process is executed in the process loop of S30.

Initially, the control unit 22 determines whether the current value (total) is either larger or smaller than the power-saving target value (S31). When the current value (total) is equal to or smaller than the power-saving target value, this is determined in S31. Here, the power-saving mode switching process is terminated by recognizing that a request to save power to the downstream side connected to a different outlet 11 is not needed. When the current value (total) is larger than the power-saving target value, this is determined in S31. Then, the flow proceeds to S32.

In S32, the control unit 22 calculates a power-saving target value to be targeted by the downstream side connected to the outlet 11 to be targeted. The control unit 22 causes the communication unit 21 to transmit the calculated power-saving target value to the downstream side (S33).

A power-saving target value for each of the outlets 11 is calculated, for example, by causing a downstream side of each outlet 11 to share a difference between the power-saving target value and the current value (total). Specifically, the power-saving target value is calculated, for example, with the following formula.

power-saving target value=current value (OLx)−(current value (total))−MAX (input power-saving target value, power-saving value (total))×(current value (OLx)−power-saving value (OLx))÷(current value (total)−power-saving value (total)) (1)

In this formula (1), when a terminal 5 is not present on the downstream side, a value of the second term on the right side becomes 0, and a calculated power-saving value matches the current value (OLx). In the meantime, when the terminal 5 is present on the downstream side, the value of the second term on the right side becomes positive, and the calculated power-saving target value becomes smaller than the current value (OLx). The reason why such a formula (1) is employed is that only power saving of an outlet 11 having a terminal 5 on a downstream side is assumed. In other words, the reason is that terminals 5 and 7 for which a power supply is shut off do not occur at this point of time.

When the downstream side to which the power-saving target value is transmitted is the terminal 5, the control unit 62 of the power management device 6 of the terminal 5 controls the breaker 58 to shut off a power supply to the addition unit 57. Thus, the amount of power supplied from the outlet 11 to be targeted is reduced. In the meantime, when the downstream side to which the power-saving target value is transmitted is a different power relay device 1, the power relay device 1 executes the power-saving mode switching process by receiving the power-saving target value.

After the control unit 22 transmits the power-saving target value, the control unit 22 executes the measurement process illustrated in FIG. 4 (S34). The reason why the control unit 22 executes the measurement process is to verify a power-saving effect achieved by transmitting the power-saving target value. A result of the verification is used when the process of S31 is executed next.

After the control unit 22 executes the measurement process, the control unit 22 determines whether an outlet 11 to be targeted is present. When the outlet 11 to be targeted is present, the process of S31 is again executed. When the outlet 11 to be targeted is not present, the process loop of the S30 is terminated. Thus, also the power-saving mode switching process is terminated.

Returning to the description of S23 and subsequent steps of FIG. 5.

In S23, the control unit 22 determines whether the current value (total) is either larger or smaller than the power-saving target value. When the current value (total) is equal to or smaller than the power-saving target value, this is determined in S23. Here, the power-saving process is terminated. When the current value (total) is larger than the power-saving target value, this is determined in S23, and the flow proceeds to S24.

Proceeding of the flow to S24 means that needed reductions in the power consumption is not attained only by causing all the terminals 5 present on the downstream side to make a transition to the power-saving mode. Thus, in S24, the control unit 22 executes the shut-off control process for shutting off a power supply to the terminals 5 and 7 for which a power supply is shut off. Thereafter, this power-saving process is terminated.

In this embodiment, the above described power-saving process is executed by using an input of the power-saving target value. However, a power-saving target value may be preset, and the power-saving process may be automatically executed when the current value (total) exceeds the preset power-saving target value. Moreover, a transition of the terminal 5 to the power-saving mode may be performed merely to reduce power consumption. Namely, the power-saving mode switching process may be executed separately from the shut-off control process. Thus, the power-saving mode switching process may be executed merely by a request to execute the process.

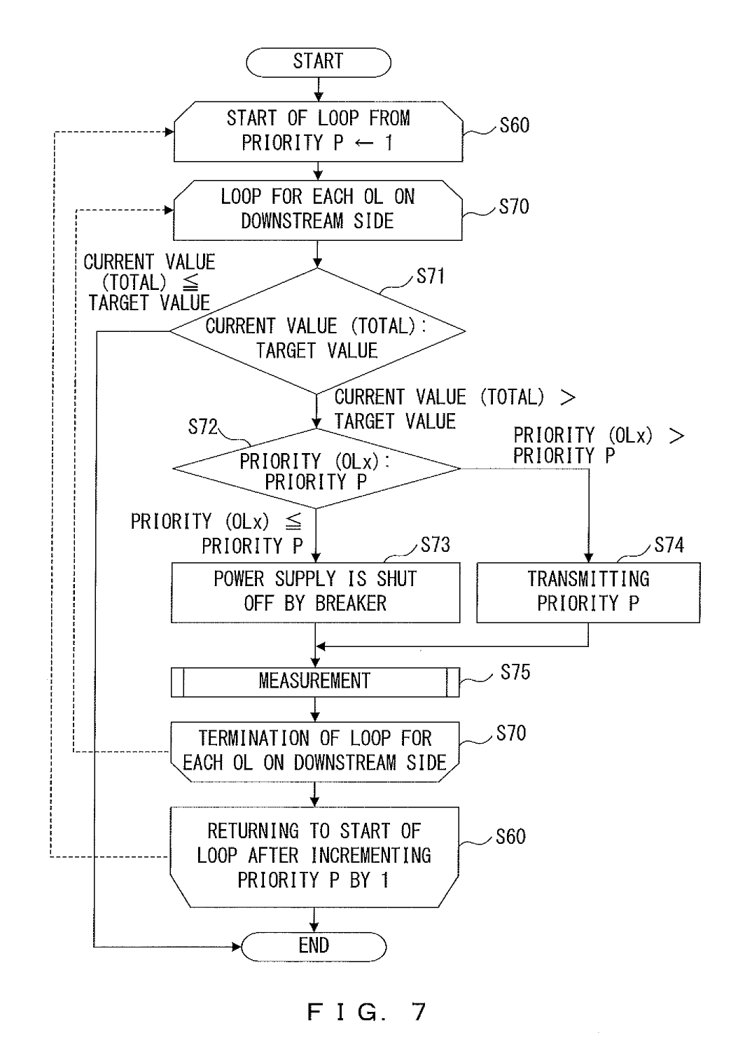

FIG. 7 is a flowchart illustrating the shut-off control process. The shut-off control process is described in detail next with reference to FIG. 7.

A power supply is shut off for each of the outlets 11. The terminals 5 and 7 for which a power supply is be shut off are decided by referencing priorities as described above. Therefore, a process loop (S60) including a process loop (S70) for shutting off a power supply to the terminals 5 and 7 for which a power supply needs to be shut off is present in the shut-off control process while a target outlet 11 is being changed. The process loop of S60 is intended to shut off a power supply to the terminals 5 and 7 having a priority equal to or lower than a target priority while sequentially incrementing the target priority.

In the process loop of S60, 1 is set as an initial priority. In FIG. 7, this is expressed as “priority P←1”. Hereinafter, “priority P” is used as a term that expresses a target priority. In the process loop of S70, an outlet 11 having the smallest outlet number is the initial target.

First of all, the control unit 22 determines whether the current value (total) is either larger or smaller than the power-saving target value (S71). When the current value (total) is equal to or smaller than the power-saving target value, this is determined in S71. Here, the shut-off control process is terminated by recognizing that a further shut-off of a power supply is not needed. When the current value (total) is larger than the power-saving target value, this is determined in S71, and the flow proceeds to S72.

In S72, the control unit 22 determines whether the priority (OLx) of the outlet 11 to be targeted is either higher or lower than the priority P. When the priority (OLx) is equal to or lower than the priority P, this is determined in S72. In this case, the control unit 22 controls the breaker 25 of the outlet 11 to be targeted to shut off a power supply (S73). Thereafter, the control unit 22 executes the measurement process in order to verify a result of shutting off the power supply (S75).

In the meantime, when the priority (OLx) is higher than the priority P, this is determined in S72. In this case, the control unit 22 instructs the communication unit 21 to transmit the priority P to the downstream side of the outlet 11 to be targeted (S74). A transmission of the priority P is based on the premise that a different power relay device 1 is connected on the downstream side. Since the priority (total) transmitted by the power relay device 1 is the maximum value of the priories (OLx), there is a possibility that an outlet having a priority (OLx) lower than the priority P is present. Therefore, the power relay device 1 that has received the priority P shuts off the power supply from the outlet 11 having the priority (OLx) lower than the priority P. Thus, the flow proceeds to S75 thereafter.

After the control unit 22 executes the measurement process of S75, the control unit 22 determines whether a different outlet 11 to be targeted is present by executing the process loop of S70. When the different outlet 11 to be targeted is present, a target outlet is changed, and the process of S71 is again executed. When the different outlet 11 to be targeted is not present, the process loop of S70 is terminated, and the control unit 22 determines whether the current priority P is the maximum value by executing the process loop of S60. When the priority P is not the maximum value, the control unit 22 increments the priority P by 1, changes a target outlet 11 to the outlet 11 to be targeted having the smallest outlet number, and again executes S71. When the priority P is the maximum value, the shut-off control process is terminated here. This termination means that a needed reduction in the power consumption is not attained.

The power relay device 1 to which the priority P has been transmitted with the process of S74 executes the shut-off control process illustrated in FIG. 7. However, the process loop of S60 is not present, and only the received priority P is targeted. This is because an outlet 11 having a priority (OLx) higher than the received priority P is not caused to shut off a power supply. To an outlet to which a different power relay device 1 is connected on the downstream side, the received priority P is transmitted.

In this way, even though a power supply to the terminals 5 and 7 is shut off, a power supply to a needed number of terminals 5 and 7 in an ascending order of priorities is shut off. Accordingly, a power supply only to a minimum number of terminals 5 and 7 having a lower degree of importance is shut off.

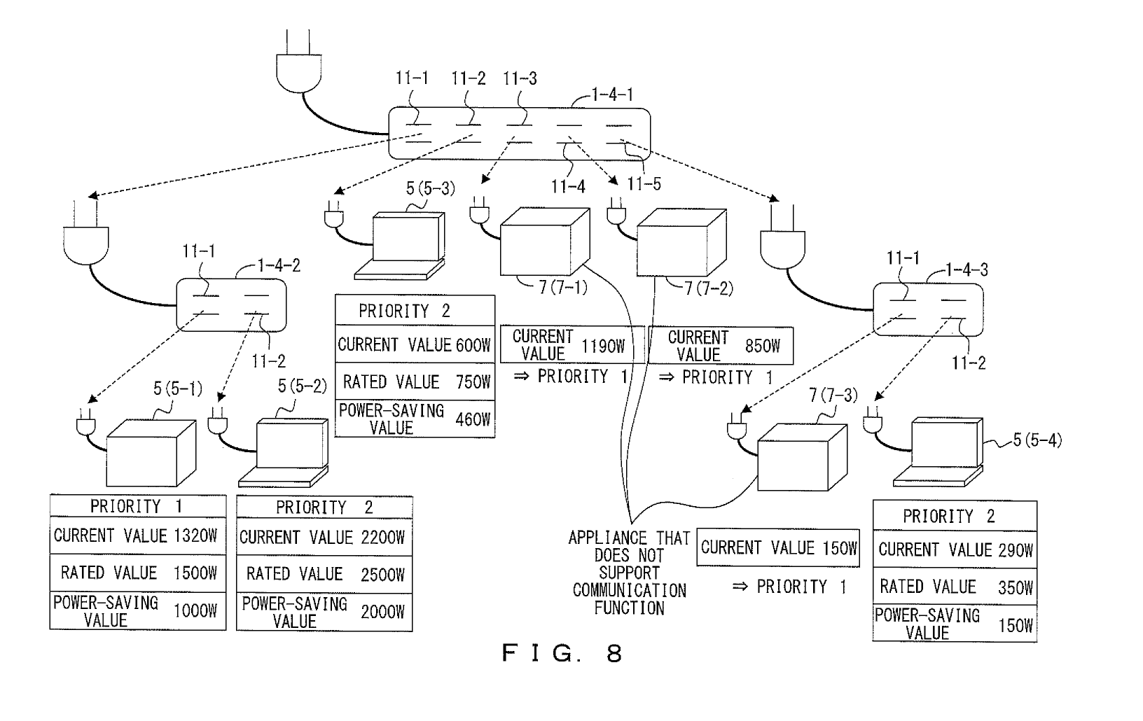

FIG. 8 is an explanatory diagram of an example of actually used power relay devices, and terminals respectively connected to the power relay devices.

In the example illustrated in FIG. 8, the power relay devices 1-4-2 and 1-4-3, which are two power strips provided with two outlets 11-1 and 11-2, are connected to a power relay device 1-4-1, which is a power strip provided with five outlets 11-1 to 11-5. The power relay devices 1-4-2 and 1-4-3 are respectively connected to the outlets 11-1 and 11-5 of the power relay device 1-4-1. To the outlets 11-2 to 11-4 of the power really device 1-4-1, terminals 5-3, 7-1 and 7-2 are respectively connected.

To the outlets 11-1 and 11-2 of the power relay device 1-4-2, the terminals 5-1 and 5-2 are respectively connected. To the outlets 11-1 and 11-2 of the power relay device 1-4-3, terminals 7-3 and 5-4 are respectively connected.

The terminal 5-1 is an electric appliance having a priority “1”, the current value 1320 W, a rated value 1500 W, and a power-saving value 1000 W. The terminal 5-2 is an electric appliance having a priority “2”, the current value 2200 W, a rated value 2500 W, and a power-saving value 2000 W. The terminal 5-3 is an electric appliance having a priority “2”, the current value 600 W, a rated value 750 W, and a power-saving value 460 W. The terminal 5-4 is an electric appliance having a priority “2”, the current value 290 W, a rated value 350 W, and a power-saving value 150 W.

In the meantime, the terminals 7-1 to 7-3 are electric appliances respectively having the current values 1190 W, 850 W, and 150 W. These terminals 7-1 to 7-3 are appliances that do not support a function of communicating with the connected power relay device 1-4. Therefore, 1 is set as a priority.

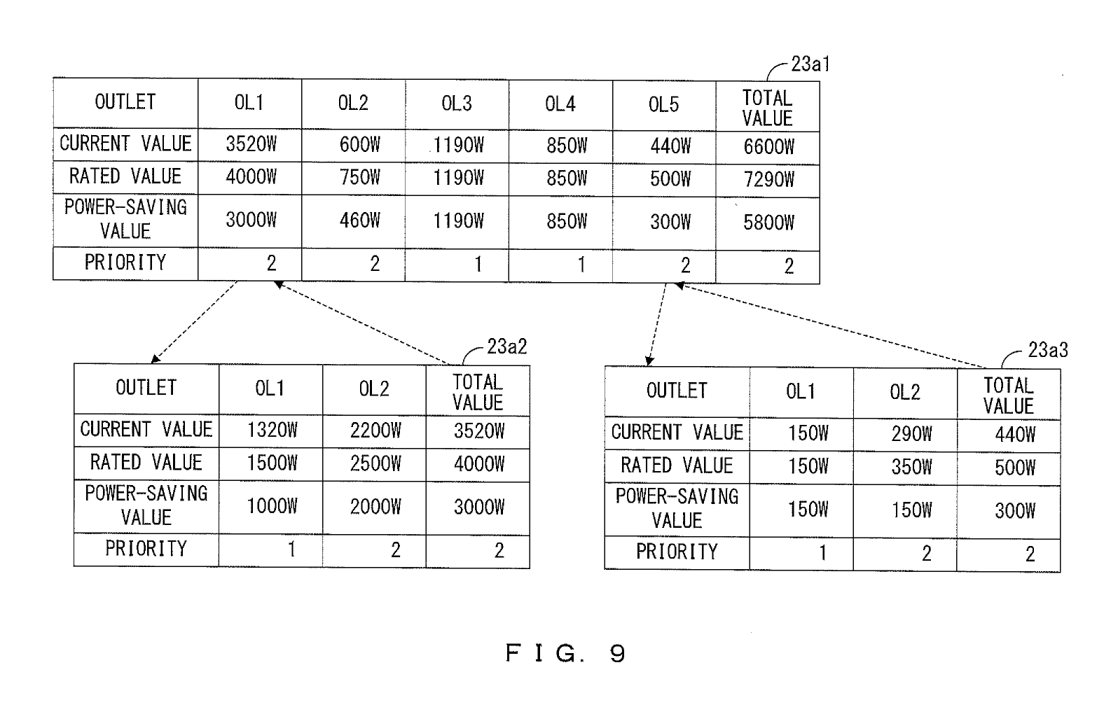

FIG. 9 is an explanatory diagram of content of power management information retained in each of the power relay devices in the case of the connection configuration illustrated in FIG. 8. In FIG. 9, any of 23a1 to 23a3 is assigned to the power management information as a reference numeral. 23a1 represents the power management information retained in the power relay device 1-4-1. Similarly, 23a2 and 23a3 represent the power management information respectively retained in the power relay devices 1-4-2 and 1-4-3. As illustrated in FIG. 9, a rated value and a power-saving value are equal to the current value in the terminals 7-1 to 7-3.

When a power-saving target value is input to the power relay device 1-4-1 in the connection configuration illustrated in FIG. 8, the power relay devices 1-4-1 to 1-4-3 operate as follows. Operations of the power relay devices 1-4-1 to 1-4-3 are specifically described by citing examples of power-saving target values.

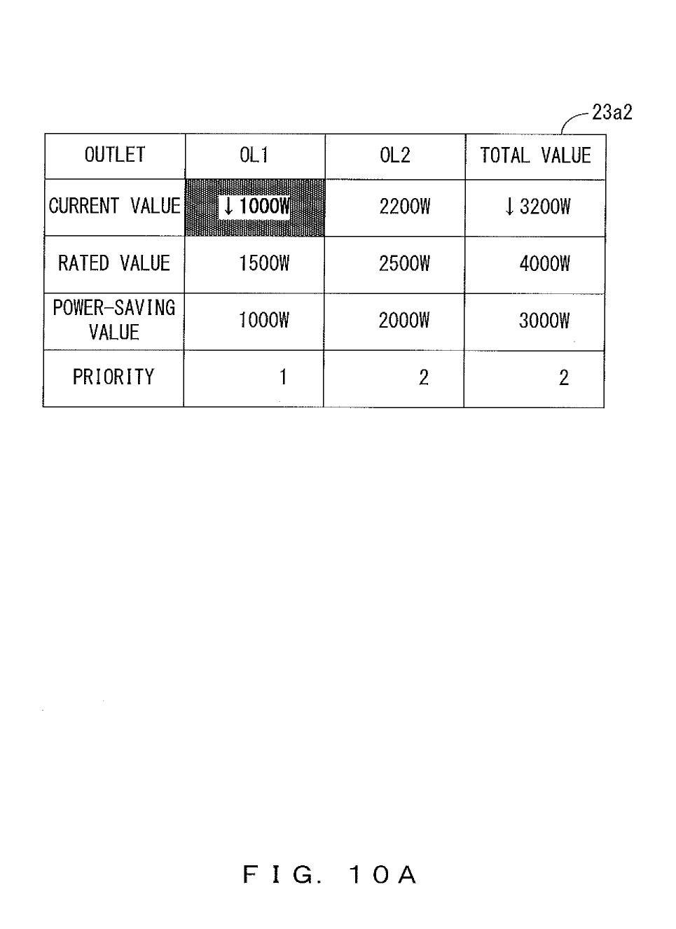

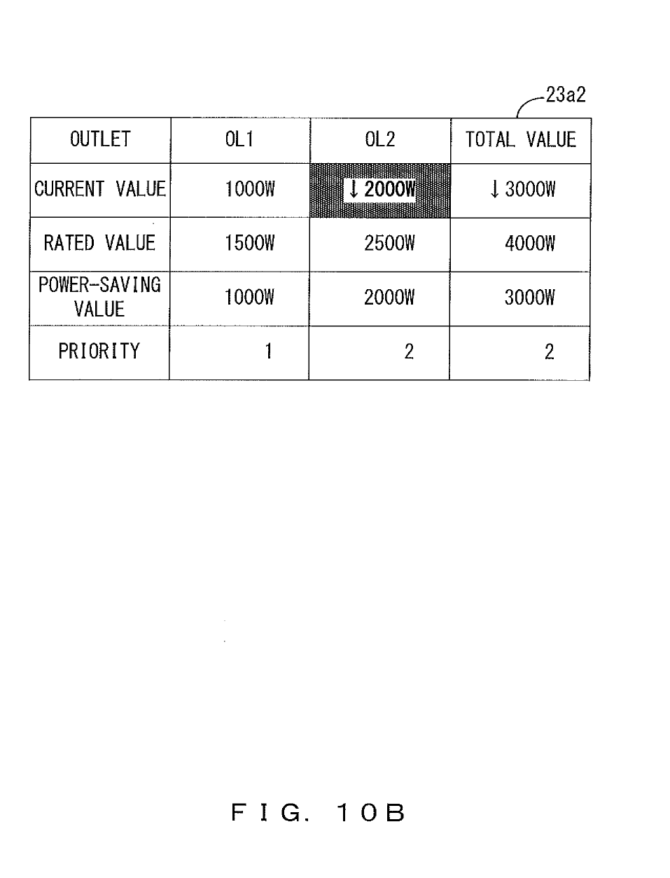

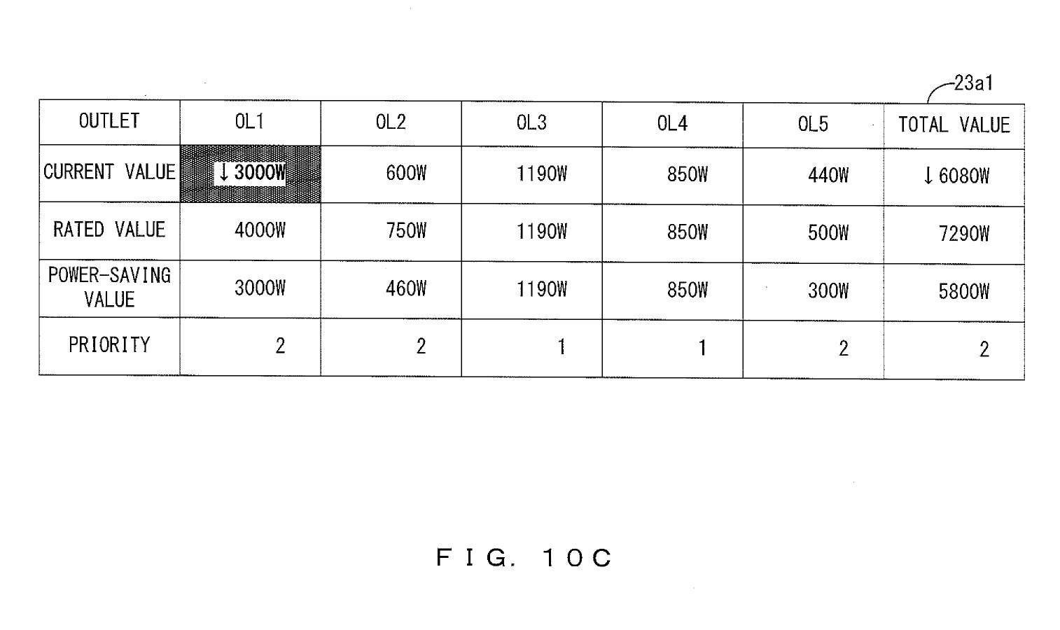

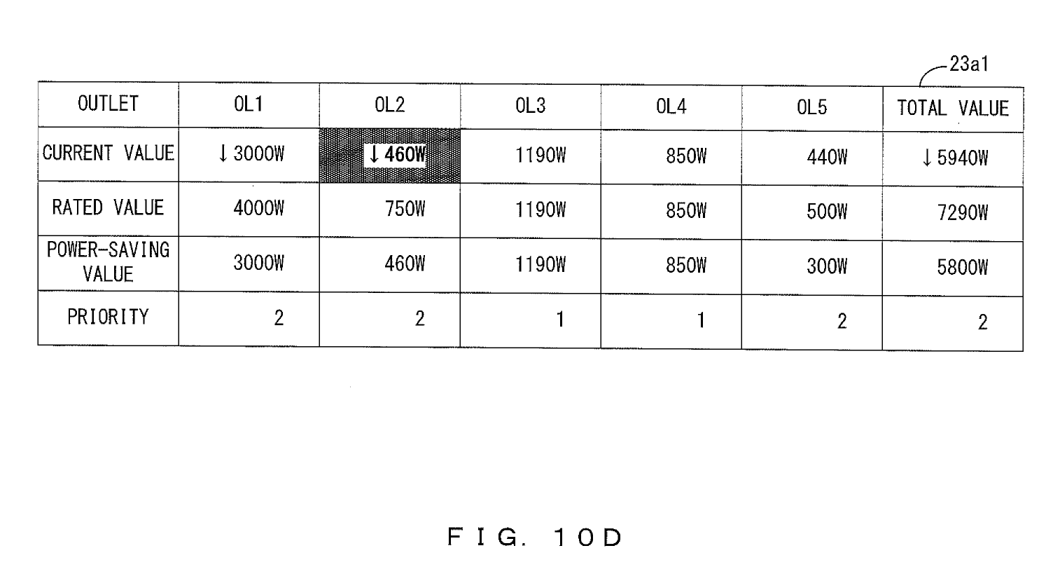

Initially, a case where 6000 W is input as a power-saving target value is specifically described with reference to FIGS. 10A to 10D. FIGS. 10A to 10D are explanatory diagrams of a change in content of the power management information retained in the power relay devices 1-4-1 to 1-4-2 in a way such that the power relay device 1-4-1 executes the power-saving process.

Since the current value (total) is 6600 W as illustrated in FIG. 9, the power relay device 1-4-1 calculates a power-saving target value to be transmitted to the power relay device 1-4-2 connected to the outlet 11-1 when 6000 W is input as the power-saving target value. 3120 W is calculated with the formula (1) as the power-saving target value. The calculated power-saving target value is transmitted to the power relay device 1-4-2.

The power relay device 1-4-2 causes the terminal 5-1 connected to the outlet 11-1 to make a transition to the power-saving mode by receiving the power-saving target value. As a result, the current value of the outlet 11-1 drops to 1000 W equal to the power-saving value as illustrated in FIG. 10A. However, even though the current value of the outlet 11-1 drops to 1000 W, the current value (total) is 3200 W, which is higher than the power-saving target value 3120 W. Accordingly, the power relay device 1-4-2 causes the terminal 5-2 connected to the outlet 11-2 to make a transition to the power-saving mode. As a result, the current value of the outlet 11-2 drops to 2000 W equal to the power-saving value as illustrated in FIG. 10B, and the current value (total) becomes 3000 W, which is equal to or lower than the power-saving value 3120 W.

The power relay device 1-4-1 verifies that the amount of power supplied from the outlet 11-1 is 3000 W by executing the measurement process, and updates the power management information as illustrated in FIG. 10C. However, the current value (total) is 6060 W, which is higher than the power-saving target value 6000 W. Accordingly, the power relay device 1-4-1 calculates a power-saving target value for the terminal 5-3 connected to the outlet 11-2, and instructs the terminal 5-3 to make a transition to the power-saving mode. At this time, the calculated power-saving target value is 560 W.

The terminal 5-3 makes a transition to the power-saving mode in accordance with the instruction to make a transition to the power-saving mode issued from the power relay device 1-4-1. As a result, the power relay device 1-4-1 verifies that the amount of power supplied from the outlet 11-2 is 460 W by executing the measurement process, and updates the power management information as illustrated in FIG. 10D. The current value (total) after being updated is 5940 W, which is lower than the power-saving target value 6000 W. Accordingly, the power relay device 1-4-1 terminates the power-saving process.

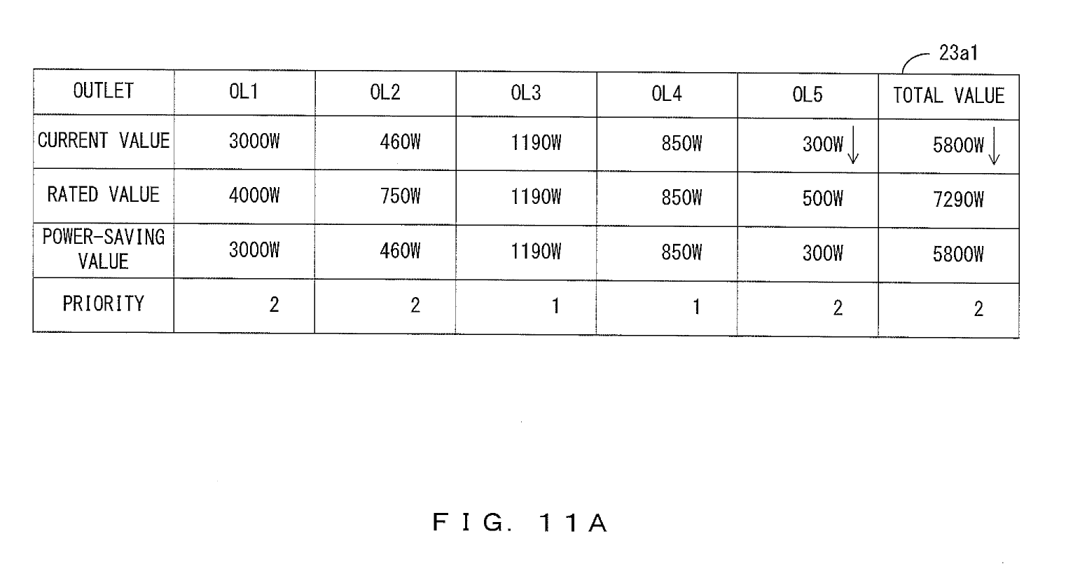

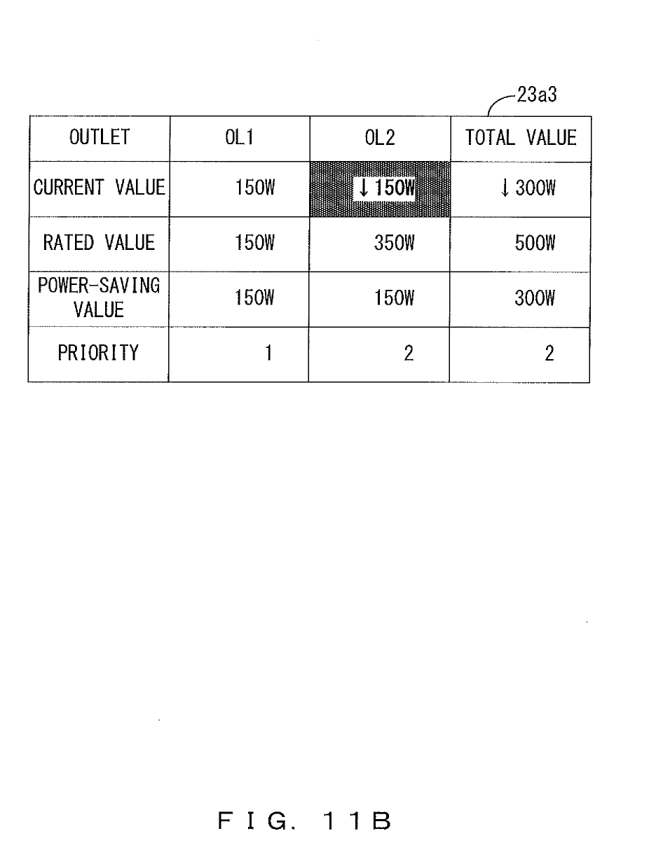

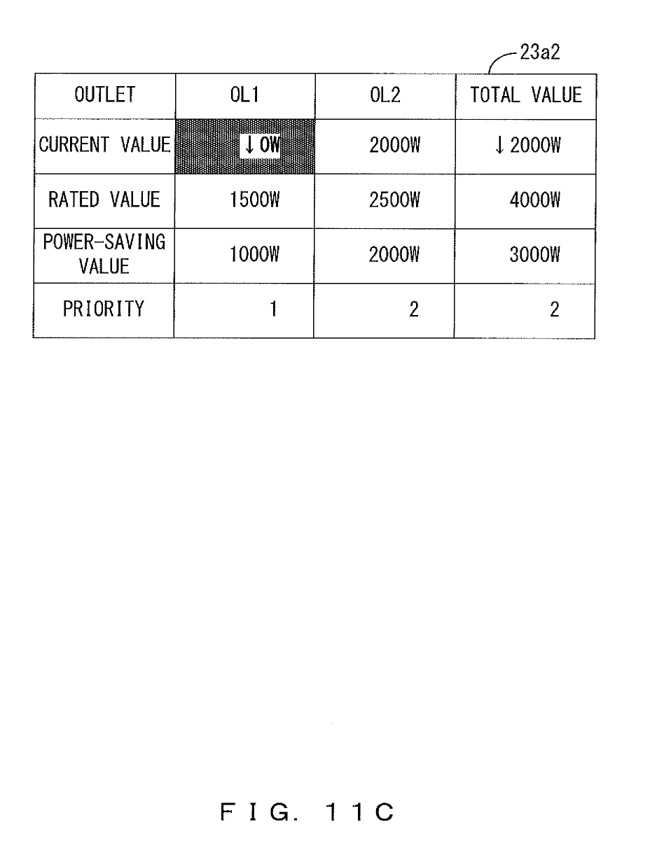

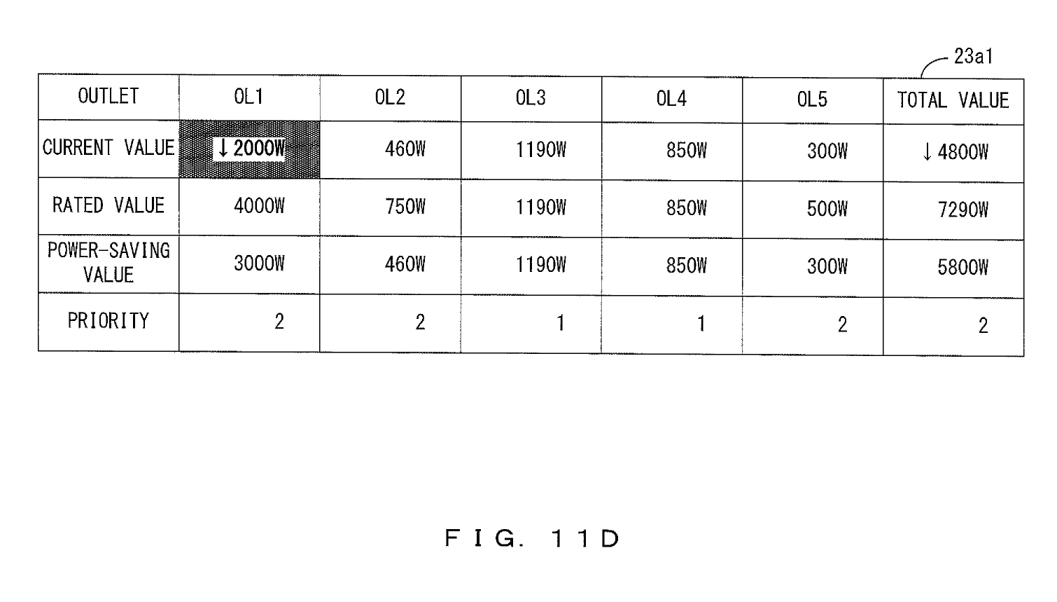

Next, a case where 5600 W is input as a power-saving target value is specifically described with reference to FIGS. 11A to 11D. FIGS. 11A to 11D are explanatory diagrams of a change in content of the power management information retained in the power relay devices 1-4-1 to 1-4-3 in away such that the power relay device 1-4-1 executes the power-saving process.

Even though the power relay device 1-4-1 causes the terminal 5-3 connected to the outlet 11-2 to make a transition to the power-saving mode, the current value does not become equal to or lower than the power-saving target value 5600 W. Accordingly, the power relay device 1-4-1 calculates a power-saving target value to be transmitted to the power relay device 1-4-3 connected to the outlet 11-5, and transmits the calculated power-saving target value to the power relay device 1-4-3. Thus, the power relay device 1-4-3 causes the terminal 5-4 connected to the outlet 11-2 to make a transition to the power-saving mode. As a result, the power relay device 1-4-1 updates the current value (OL5) of the outlet 11-5 from 440 W to 300 W as illustrated in FIG. 11A, and updates the current value (total) from 5940 W to 5800 W as illustrated in FIG. 11A. As illustrated in FIG. 11B, the power relay device 1-4-3 updates the current value (OL2) of the outlet 11-2 from 300 W to 150 W, and updates the current value (total) from 440 W to 300 W.

5800 W, which is the current value (total) after being updated as illustrated in FIG. 11A, is higher than 5600 W input as the power-saving target value. This means that the current value (total) does not become equal to or lower than 5600 W even though all the terminals 5-1 to 5-4 directly or indirectly connected to the power relay device 1-4-1 are caused to make a transition to the power-saving mode. Thus, the power relay device 1-4-1 executes the shut-off control process illustrated in FIG. 7. Accordingly, the power relay device 1-4-1 executes the shut-off control process illustrated in FIG. 7. As a result, the power relay device 1-4-1 transmits a priority P having a value 1 to the power relay device 1-4-2.

The power relay device 1-4-2 controls the breaker 25 of the outlet 11-1 by receiving the priority P having the value 1, and shuts off a power supply from the outlet 11-1. As a result, the power relay device 1-4-2 updates the current value (OL1) of the outlet 11-1 from 1000 W to 0 W, and updates the current value (total) from 3000 W to 2000 W as illustrated in FIG. 11C. As illustrated in FIG. 11D, the power relay device 1-4-1 updates the current value (OL1) of the outlet 11-1 from 3000 W to 2000 W, and also updates the current value (total) from 5800 W to 4800 W. Since 5800 W is equal to or lower than 5600 W, the shut-off control process is terminated here.

As described above, power consumption of all the terminals 5-1 to 5-4 and 7-1 to 7-3 is initially reduced by causing the terminals 5-1 to 5-4 to make a transition to the power-saving mode. When the amount of a reduction in the power consumption is insufficient even though all the terminals 5-1 to 5-4 are caused to make a transition to the power-saving mode, a power supply is shut off until a sufficient amount of a reduction is achieved from a terminal having a lower priority among the terminals 5-1 to 5-4 and 7-1 to 7-3. In this way, a shut-off of the power supply to the terminals 5-1 to 5-4 and 7-1 to 7-4 is suppressed to a minimum.

Canceling of the power-saving state, namely, a transition from the power-saving mode to the normal mode of the terminal 5, or/and a resumption of the power supply may be performed, for example, by causing the power relay device 1 provided with the key group 26 to input a command for issuing a request to cancel the power-saving mode. In order to handle a change in a situation of the terminals 5 and 7, each power relay device 1 is caused to make a transition from the power-saving mode to the normal mode, and/or to resume a power supply, and a needed transition to the power-saving mode, and in addition, a shut-off of a power supply may be again performed on the basis of a result of the transition and/or the resumption.

One system to which the present invention is applied can reduce power consumption of the whole of an electric appliance without shutting off a power supply to the electric appliance.

In this embodiment, the power relay device 1 instructs the terminal 5 to make a transition to the power-saving mode via a power line. This is intended to eliminate the need for a signal line that connects the power relay device 1 and the terminal 5. Eliminating the need for a different signal line brings about advantages in the convenience of arranging the power relay device 1, and a cost reduction. To support the terminal 5 not equipped with a communication function via a power line, an instruction to make a transition to the power-saving mode may be issued via a different signal line.

Additionally, in this embodiment, a priority is retained in the terminal 5 as information. Each power relay device 1 may obtain the priority directly or indirectly from an external device other than the terminal 5. Moreover, all the terminals 5 are caused to make a transition to the power-saving mode. However, only a needed number of terminal 5 may be caused to make a transition to the power-saving mode.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A power relay device, comprising:
one or more outlets configured to supply power to a downstream side;
a communication device configured to communicate with the downstream side connected to the outlet for each of the outlets; and
a processor configured to be able to issue, by using the communication device, a request to operate a power-saving function to a first electric appliance having the power-saving function among electric appliances positioned on the downstream side of the outlet for each of the outlets.

2. The power relay device according to claim 1, further comprising
an input device configured to input power amount information representing an amount of power that can be supplied, wherein
the processor identifies, by using the communication device, an outlet to which the first electric appliance is connected, when the input device inputs the power amount information, and is able to issue the request to the first electric appliance connected to the identified outlet.

3. The power relay device according to claim 1, wherein
the processor identifies, by using the communication device, an outlet to which a different power relay device is connected, creates the power amount information to be transmitted to the identified outlet, and causes the created power amount information to be transmitted to the different power delay device.

4. The power relay device according to claim 2, further comprising:
a measurement device configured to measure the amount of power supplied from the outlet for each of the outlets; and
a shut-off device configured to shut off a power supply to the outlet for each of the outlets, wherein
when a total amount of power obtained by the measurement device exceeds the amount of power represented by the power amount information as a result of issuing the request or transmitting the power amount information, the processor identifies an outlet for which a power supply is shut off, and causes the shut-off device to shut off the power supply to the identified outlet.

5. The power relay device according to claim 4, wherein
when a second electric appliance that retains priority information representing a priority when the power supply is shut off is present among the electric appliances, the processor verifies the priority information retained by the second electric appliance by using the communication device, and reflects a result of verification on identification of the outlet for which the power supply is shut off.

6. A power consumption reduction method, comprising:
by using one or more power relay devices having one or more outlets for supplying power to a downstream side, causing, by a processor, a first electric appliance having a power-saving function among electric appliances to which the power is supplied from any of the power relay devices to operate the power-saving function; and
when the amount of power supplied to all the electric appliances exceeds a specified amount of power as a result of causing the first electric appliance to operate the power-saving function, identifying, by the processor, an electric appliance for which the power supply is shut off among all the electric appliances, and shutting off, by the processor, the power supply to the identified electric appliance.
